(19) United States
(12) Patent Application Publication
(10) Pub. No.: US 2009/0273711 A1
(43) Pub. Date: Nov. 5, 2009

(54) METHOD AND APPARATUS FOR CAPTION PRODUCTION

(75) Inventors: Claude Chapdelaine, Montreal (CA); Mario Beaulieu, Montreal (CA); Langis Gagnon, Laval (CA)

Correspondence Address: DARBY & DARBY P.C., P.O. BOX 770, Church Street Station, New York, NY, 10008-0770, US

(73) Assignee: Centre de Recherche Informatique de Montreal (CRIM), Montreal (CA)

(21) Appl. No.: 12/360,785

(22) Filed: Jan. 27, 2009

Related U.S. Application Data
(60) Provisional application No. 61/049,105, filed on Apr. 30, 2008.

(51) Int. Cl. H04N 7/00; G06K 9/34

(52) U.S. Cl. 348/465; 382/176; 348/E07.001

(57) ABSTRACT

A method for determining a location of a caption in a video signal associated with a Region Of Interest (ROI), such as a face or text, or an area of high motion activity. The video signal is processed to generate ROI location information, the ROI location information conveying the position of the ROI in at least one video frame. The position where a caption can be located within one or more frames of the video signal is then determined on the basis of the ROI location information. This is done by identifying at least two possible positions for the caption in the frame such that the placement of the caption in either one of the two positions will not mask the ROI. A selection is then made among the at least two possible positions. The position picked is the one that would typically be the closest to the ROI such as to create a visual association between the caption and the ROI.

### CROSS-REFERENCE TO RELATED APPLICATION

This application claims priority from U.S. Provisional Patent Application No. 61/049,105 filed on Apr. 30, 2008 and hereby incorporated by reference herein.

### FIELD OF THE INVENTION

The invention relates to techniques for producing captions in a video image. Specifically, the invention relates to an apparatus and to a method for processing a video image signal to identify one or more areas in the image where a caption can be located.

### BACKGROUND OF THE INVENTION

Deaf and hearing impaired people rely on captions to understand video content. Producing caption involves transcribing what is being said or heard and placing this text for efficient reading while not hindering the viewing of the visual content. Caption is presented in either two possible modes: 1) off-line; if it can be produced before the actual broadcasting or 2) on-line; meaning it is produced in real-time during the broadcast.

Off-line caption is edited by professionals (captioners) to establish accuracy, clarity and proper reading rate, thus offering a higher presentation quality than on-line caption which is not edited. Besides editing, captioners have to place captions based on their assessment of the value of the visual information. Typically, they place the caption such as it does not mask any visual element that may be relevant to the understanding of the content. Therefore, this task can be quite labor-intensive; it could require up to 18 hours producing off-line captions for one hour of content.

Off-line captions are created as a post-production task of a film or a television program. Off-line caption is a task of varying execution time depending on the complexity of the subject, the speaking rate, the number of speakers and the rate and length of the shot. Trained captioners view and listen to a working copy of the content to be captioned in order to produce a transcript of what is being said, and to describe any relevant non-speech audio information such as ambient sound (music, gunshot, knocking, barking, etc. . . . ) and people reaction (laughter, cheering, applause, etc. . . . ). The transcripts are broken into smaller text units to compose a caption line of varying length depending on the presentation style used. For off-line caption, two styles are recommended: the pop-up and the roll-up.

In a pop-up style, captions appear all at once in a group of one to three lines layout. An example of a pop-up style caption is shown in FIG. 1. This layout style is recommended for dramas, sitcoms, movies, music video, documentaries and children's programs. Since each instance of pop-up lines has to be placed, they require more editing. They have varying shapes and can appear anywhere on the image creating large production constraints on the captioners.

In a roll-up style, text units will appear one line at the time in a group of two or three lines where the last line pushes the first line up and out. An example of a roll-up style caption is shown in FIG. 2. They are located in a static region. The roll-up movement indicates the changes in caption line. This style is better suited for programs with high speaking rate and/or with many speakers such as news magazine, sports and entertainment.

In the case of live or on-line captioning, the constraints are such that up to now, the captions suffer from a lower quality presentation than off-line captions since the on-line captions cannot be edited. The on-line caption text is typically presented in a scroll mode similar to off-line roll-up except that words appear one after the other. The on-line captions are located on a fixed region of two to three lines at the bottom or the top of the screen. They are used for live news broadcast, sports or any live events in general.

It will therefore become apparent that a need exists in the industry to provide an automated tool that can more efficiently determine the position of captions in a motion video image.

### SUMMARY OF THE INVENTION

As embodied and broadly described herein, the invention provides a method for determining a location of a caption in a video signal associated with an ROI (Region of Interest). The method includes the following steps:
a) processing the video signal with a computing device to generate ROI location information, the ROI location information conveying the position of the ROI in at least one video frame;
b) determining with the computing device a position of a caption within one or more frames of the video signal on the basis of the ROI location information, the determining, including:
   i) identifying at least two possible positions for the caption in the frame such that the placement of the caption in either one of the two positions will not mask fully or partially the ROI;
   ii) selecting among the at least two possible positions an actual position in which to place the caption, at least one of the possible positions other than the actual position being located at a longer distance from the ROI than the actual position;
c) outputting data conveying the actual position of the caption.

As embodied and broadly described herein, the invention further provides a system for determining a location of a caption in a video signal associated with an ROI, wherein the video signal includes a sequence of video frames, the system comprising:
a) an input for receiving the video signal;
b) an ROI detection module to generate ROI location information, the ROI location information;
c) a caption positioning engine for determining a position of a caption within one or more frames of the video signal on the basis of the ROI location information, the caption positioning engine:
   i) identifying at least two possible positions for the caption in the frame such that the placement of the caption in either one of the two positions will not mask fully or partially the ROI;
   ii) selecting among the at least two possible positions an actual position in which to place the caption, at least one of the possible positions other than the actual position being located at a longer distance from the ROI than the actual position;
d) an output for releasing data conveying the actual position of the caption.

As embodied and broadly described herein the invention also provides a method for determining a location of a caption in a video signal associated with an ROI, wherein the video signal includes a sequence of video frames, the method comprising:
a) processing the video signal with a computing device to generate ROI location information;
b) determining with the computing device a position of a caption within one or more frames of the video signal on the basis of the ROI location information, the determining, including:
   i) selecting a position in which to place the caption among at least two possible positions, each possible position having a predetermined location in a video frame, such that the caption will not mask fully or partially the ROI;
c) outputting at an output data conveying the selected position of the caption.

### BRIEF DESCRIPTION OF THE DRAWINGS

A detailed description of examples of implementation of the present invention is provided hereinbelow with reference to the following drawings, in which:

FIG. 1 is an on-screen view showing an example of a pop-up style caption during a television show;

FIG. 2 is an on-screen view showing an example of a roll-up style caption during a sporting event;

FIG. 3 is a block diagram of a non-limiting example of implementation of an automated system for caption placement according to the invention;

FIG. 4 is an on-screen view illustrating the operation of a face detection module;

FIG. 5 is an on-screen view illustrating the operation of a text detection module;

FIG. 6 is an on-screen view illustrating a motion activity map;

FIG. 7 is an on-screen view illustrating a motion video image on which is superposed a Motion Activity Grid (MAG);

FIG. 8 is an on-screen view illustrating a Graphical User Interface (GUI) allowing a human operator to validate results obtained by the automated system of FIG. 3;

FIG. 9 is an on-screen view of an image illustrating the visual activity of hearing impaired people observing the image, in particular actual face hits;

FIG. 10 is an on-screen view of an image illustrating the visual activity of people having no hearing impairment, in particular discarded faces;

FIG. 11 is a graph illustrating the results of a test showing actual visual hits per motion video type for people having no hearing impairment and hearing impaired people;

FIG. 12 is a graph illustrating the results of a test showing the percentage of fixations outside an ROI and the coverage ratio per motion video type for people having no hearing impairment and hearing impaired people;

FIG. 13 is a flowchart illustrating the operation of the production rules engine shown in the block diagram of FIG. 3;

FIG. 14 is a graph illustrating the velocity magnitude of a visual frame sequence;

FIG. 15 illustrates a sequence of frames showing areas of high motion activity;

FIG. 16 is an on-screen view showing a motion video frame on which high motion areas have been disqualified for receiving a caption;

FIGS. 17a, 17b, 17c and 17d are on-screen shots of frames illustrating a moving object and the definition of an aggregate area protected from a caption.

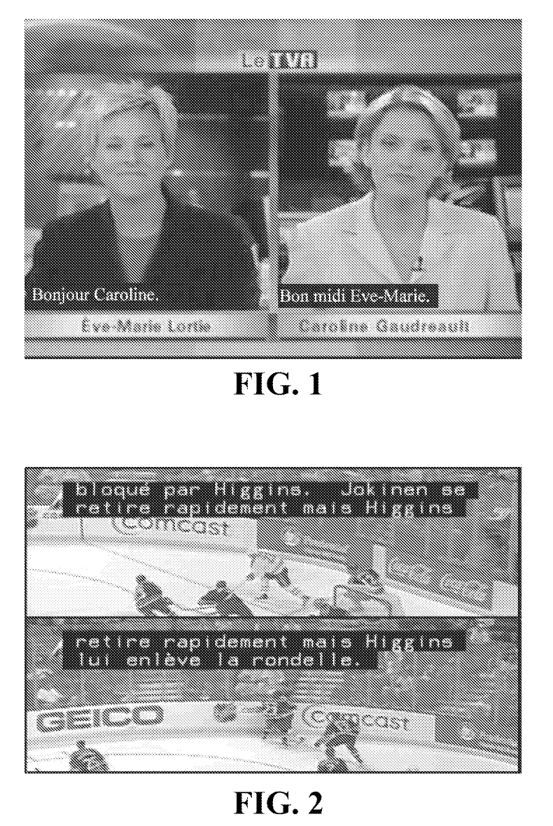

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

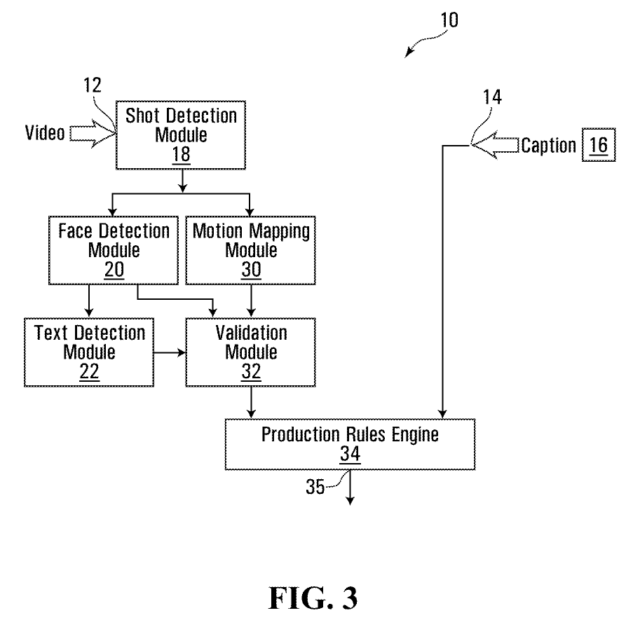

A block diagram of an automated system for performing caption placement in frames of a motion video is depicted in FIG. 3. The automated system is software implemented and would typically receive as inputs the motion video signal and caption data. The information at these inputs is processed and the system will generate caption position information indicating the position of captions in the image. The caption position information thus output can be used to integrate the captions in the image such as to produce a captioned motion video.

The computing platform on which the software is executed would typically comprise a processor and a machine readable storage medium that communicates with the processor over a data bus. The software is stored in the machine readable storage medium and executed by the processor. An Input/Output (I/O) module is provided to receive data on which the software will operate and also to output the results of the operations. The I/O module also integrates a user interface allowing a human operator to interact with the computing platform. The user interface typically includes a display, a keyboard and pointing device.

More specifically, the system 10 includes a motion video input 12 and a caption input 14. The motion video input 12 receives motion video information encoded in any suitable format. The motion video information is normally conveyed as a series of video frames. The caption input 14 receives caption information. The caption information is in the form of a caption file 16 which contains a list of caption lines that are time coded. The time coding synchronizes the caption lines with the corresponding video frames. The time coding information can be related to the video frame at which the caption line is to appear.

The motion video information is supplied to a shot detection module 18. It aims at finding motion video segments within the motion video stream applied at the input 12 having a homogeneous visual content. The detection of shot transitions, in this example is based on the mutual color information between successive frames, calculated for each RGB components as discussed in Z. Cerneková, I. Pitas, C. Nikou, “Information Theory-Based Shot Cut/Fade Detection and Video Summarization”, IEEE Trans. On Circuits and Systems for Video Technology, Vol. 16, No. 1, pp. 82-91, 2006. Cuts are identified if intensity or color is abruptly changed between two successive motion video frames.

Generally speaking the purpose of the shot detection module is to temporally segment the motion video stream. Shots constitute the basic units of film used by the other detection techniques that will be described below. Thus, shot detection is done first and serves as an input to all the others processes. Shot detection is also useful during a planning stage to get a sense of the rhythm's content to be processed. Many short consecutive shots indicate many synchronization and short delays thus implying a more complex production. In addition, shot detection is used to associate captions and shot. Each caption is associated to a shot and the first one is synchronized to the beginning of the shot even if the corresponding dialogue comes later in the shot. Also the last caption is synchronized with the last frame of a shot.

The output of the shot detection module 18 is thus information that specifies a sequence of frames identified by the shot detection module 18 that define the shot.

The sequence of frames is then supplied to Regions of Interest (ROI) detection modules. The ROI detection modules detect in the sequence of frames defining the shot regions of interest, such as faces, text or areas where significant movement exists. The purpose of the detection is to identify the location in the image of the ROIs and then determine on the basis of the ROI location information the area where the caption should be placed.

In a specific example of implementation, three types of ROI are being considered, namely human faces, text and high level of motion areas. Accordingly, the system 10 has three dedicated modules, namely a face detection module 20, a text detection module 22 and a motion mapping module 30 to perform respectively face, text and level of motion detection in the image.

Note specifically, that other ROI can also be considered without departing from the spirit of the invention. An ROI can actually be any object shown in the image that is associated to a caption. For instance, the ROI can be an inanimate object, such as the image of an automobile, an airplane, a house or any other object.

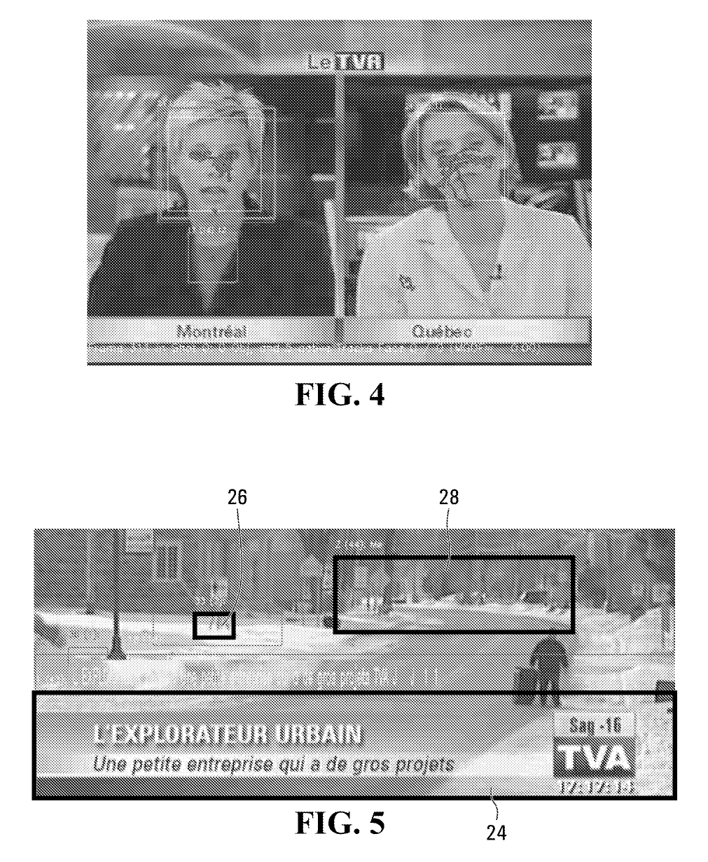

An example of a face detection module 20 is a near-frontal detector based on a cascade of weak classifiers as discussed in greater detail in P. Viola, M. J. Jones, “Rapid object detection using a boosted cascade of simple features,” CVPR, pp. 511-518, 2001 and in E. Lienhart, J. Maydt, “An extended Set of Haar-like Features for Rapid Object Detection”, ICME, 2002. Face tracking is done through a particle filter and generate trajectories as shown in FIG. 4. As discussed in R. C. Verma, C. Schmid, K. Mikolajczyk, “Face Detection and Tracking in a Video by Propagating Detection Probabilities”, IEEE Trans. on PAMI, Vol. 25, No. 10, 2003, the particle weight for a given ROI depends on the face classifier response. For a given ROI, the classifier response retained is the maximum level reached in the weak classifier cascade (the maximum being 24). Details of the face detection and tracking implementation can be found in S. Foucher, L. Gagnon, “Automatic Detection and Clustering of Actor Faces based on Spectral Clustering Techniques”, CRV, pp. 113-120, 2007.

The output of the face detection module 20 includes face location data which, in a specific and non-limiting example of implementation identifies the number and the respective locations of the faces in the image.

The text detection module 22 searches the motion video frames for text messages. The input of the text detection module includes the motion video frames to be processed and also the results of the face detection module processing. By supplying to the text detection module 22 information about the presence of faces in the image, reduces the area in the image to be searched for text, since areas containing faces cannot contain text. Accordingly, the text detection module 22 searches the motion video frames for text except in the areas in which one or more faces have been detected.

Text detection can be performed by using a cascade of classifiers trained as discussed in greater detail in M. Lalonde, L. Gagnon, “Key-text spotting in documentary videos using Adaboost”, IS&T/SPIE Symposium on Electronic Imaging: Applications of Neural Networks and Machine Learning in Image Processing X (SPIE #6064B), 2006.

Simple features (e.g. mean/variance ratio of grayscale values and x/y derivatives) are measured for various sub-areas upon which a decision is made on the presence/absence of text. The result for each frame is a set of regions where text is expected to be found. An example of text detection and recognition process are shown in FIG. 5.

The on-screen view of the image in FIG. 5 shows three distinct areas, namely areas 24, 26 and 28 that potentially contain text. Among those areas, only-the area 24 contains text while the areas 26 and 28 are false positives. Optical Character Recognition (OCR) is then used to discriminate between the regions that contain text and the false positives. More specifically, the areas that potentially contain text are first pre-processed before OCR to remove their background and noise. One possibility that can be used is to segment each potential area in one or more sub-windows. This is done by considering the centroid pixels of the potential area that contributes to the aggregation step of the text detection stage. The RGB values of these pixels are then collected into a set associated to their sub-window. A K-means clustering algorithm is invoked to find the three dominant colors (foreground, background and noise). Then, character recognition is performed by commercial OCR software.

Referring back to the block diagram of FIG. 3, the output of the text detection module 22 includes data which identifies the number and the respective locations of areas containing text in the image. By location of an area containing text in the image is meant the general area occupied by the text zone and the position of the text containing area in the image.

The motion mapping module 30 detects areas in the image where significant movement is detected and where, therefore, it may not be desirable to place a caption. The motion mapping module 30 uses an algorithm based on the Lukas-Kanade optical flow techniques, which is discussed in greater detail in B. Lucas, T. Kanade, “An Iterative Image Registration Technique with an Application to Stereo Vision”, Proc. of 7th International Joint Conference on Artificial Intelligence, pp. 674-679, 1981. This technique is implemented in a video capture/processing utility available at www.virtualdub.org.

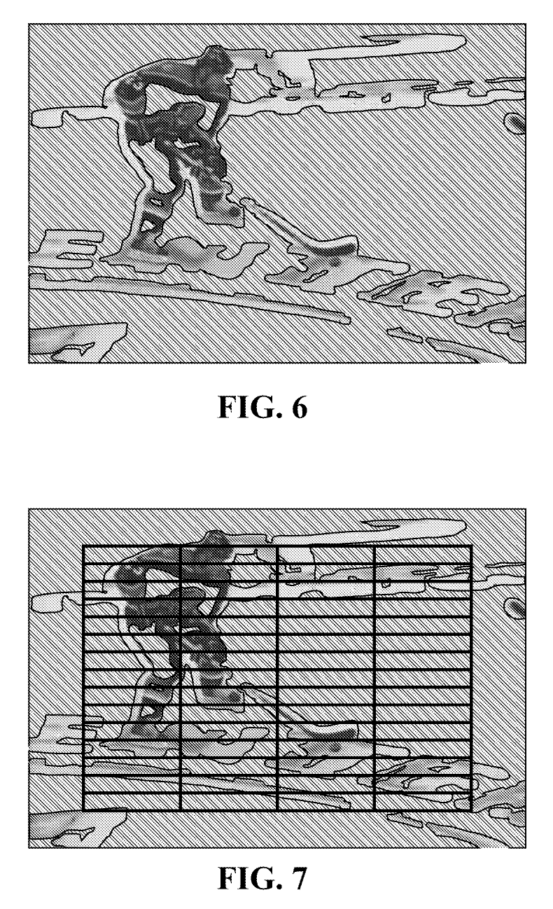

The motion mapping module 30 defines a Motion Activity Map (MAM) which describes the global motion area. The MAM performs foreground detection and masks regions where no movement is detected between two frames. This is best shown in FIG. 6 which illustrates a frame of a sporting event in which a player moves across the screen. The cross-hatchings in the image illustrate the areas where little or no movement is detected. Those areas are suitable candidates for receiving a caption since there a caption is unlikely to mask significant action events.

The mean velocity magnitude in each frame is used by the motion mapping module 30 to identify critical frames (i.e. those of high velocity magnitude). The critical frames are used to build a Motion Activity Grid (MAG) which partitions each frame into sub-section where caption could potentially be placed. For each frame, 64 sub-sections are defined for which mean velocity magnitude and direction are calculated. The frame sub-division is based on the actual television format and usage. Note that the number of sub-sections in which the frame can be subdivided can vary according to the intended applications, thus the 64 sub-sections discussed earlier is merely an example.

The standard NTSC display format of 4:3 requires 26 lines to display a caption line which is about 1/20 of height of the screen (this proportion is also the same for other format such as the HD 16:9). The standards of the Society of Motion Picture and Television Engineers (SMPTE) define the active image in the portion of the television signal as the “production aperture”. SMPTE also defines inside the “production aperture” a “save title area” (STA) in which all significant titles must appear. This area should be 80% of the production aperture width and height. The caption is expected to be in the STA.

In defining a MAG, first 20% of the width and height of the image area is removed. For example, a 4:3 format transformed into a digital format gives a format of 720×486 pixels, that is, it would be reduced to 576×384 pixels to define the STA. Giving that a caption line has a height of 24 pixels, this makes MAG of 16 potential lines. The number of columns would be a division of the 576 pixels for the maximum of 32 characters per caption line. In order to have a region large enough to place a few words, this region is divided into four groups of 144 pixels. So, the MAG of each frame is a 16×4 grid, totalizing 64 areas of magnitude velocity mean and direction. The grid is shown in FIG. 7. The grid defines 64 areas in the frame in which a caption could potentially be located. The operation of the motion mapping module 30 is to detect significant movement in the image in anyone of those areas and disqualify them accordingly, and leave only those in which the placement of a caption will not mask high action events.

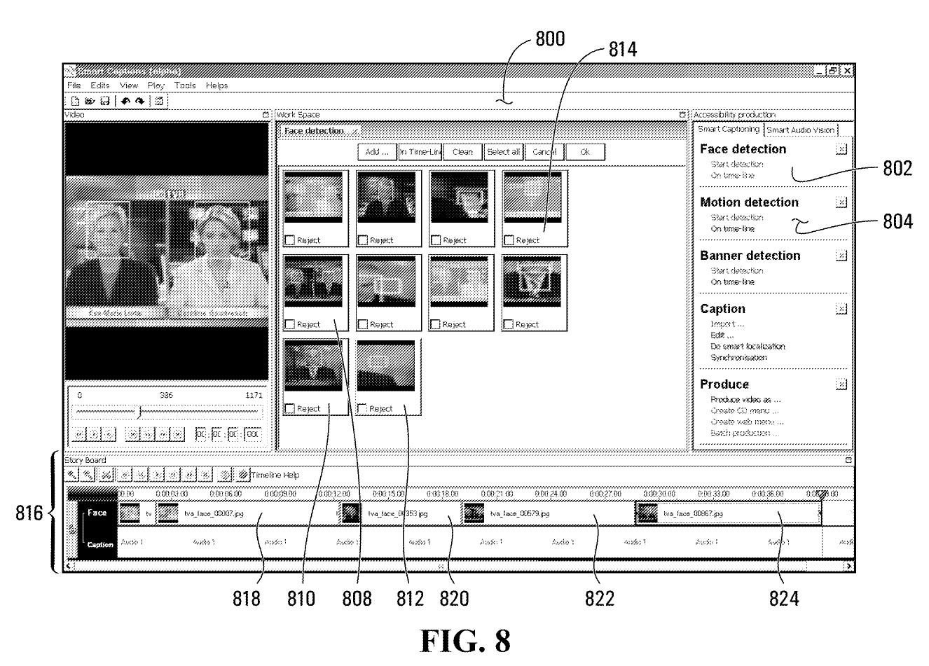

The validation block 32 is an optional block and it illustrates a human intervention step where a validation of the results obtained by the face detection module 20, the text detection module 22 and the motion mapping module 30 can be done. The validation operation is done via the user interface, which advantageously is a Graphical User Interface (GUI). An example of such a GUI is shown in FIG. 8. The GUI presents the user with a variety of options to review detection results reject the results that are inaccurate.

The GUI defines a general display area 800 in which information is presented to the user. In addition to information delivery, the GUI also provides a plurality of GUI controls, which can be activated by the user to trigger operations. The controls are triggered by a pointing device.

On the right side of the display area 800 is provided a zone in which the user can select the type of detection that he/she wishes to review. In the example shown, face 802 and motion 804 detection can be selected among other choices. The selection of a particular type of detection is done by activating a corresponding tool, such as by “clicking” on it.

The central zone of the area 800 shows a series of motion video frames in connection with which a detection was done. In the example shown, the face detection process was performed. In each frame the location where a face is deemed to exist is highlighted. It will be apparent that in most of the frames the detection is accurate. For instance in frames 806, 808 and 810 the detection process has correctly identified the position of the human face. However, in frames 812 and 814 the detection is inaccurate.

Each frame in the central zone is also associated with a control allowing rejecting the detection results. The control is in the form of a check box which the user can operate with a pointing device by clicking on it.

The left zone of the area 800 is a magnified version of the frames that appear in the central zone. That left zone allows viewing the individual frames in enlarged form such as to spot details that may not be observable in the thumbnail format in the central zone.

The lower portion of the area 800 defines a control space 816 in which appear the different shots identified in the motion video. For instance, four shots are being shown, namely shot 818, shot 820, shot 822 and shot 824. The user can select anyone of those shots and for review and editing in the right, center and left zones above. More specifically, by selecting the shot 818, the frames of the shot will appear in the central zone and can be reviewed to determine if the detection results performed by anyone of the face detection module 20, the motion mapping module 30 and the text detection module 22 are accurate.

Referring back to FIG. 3, the results of the validation process performed by validation block 32 are supplied to a rules engine 34. The rules engine 34 also receives the caption input data applied at the input 14.

The rules production engine 34 uses logic to position a caption in a motion video picture frame. The position selection logic has two main purposes. The first is to avoid obscuring an ROI such as a face or text, or an area of high motion activity. The second is to visually associate the caption with a respective ROI.

The second objective aims locating the caption close enough to the ROI such that a viewer will be able to focus at the ROI and at the same time read the caption. In other words, the ROI and the associated caption will remain in a relatively narrow visual field such as to facilitate viewing of the motion video. When the ROI is a face, the caption will be located close enough to the face such as to create a visual association therewith. This visual association will allow the viewer to read at a glance the caption while focusing on the face.

The relevance of the visual association between a caption and an ROI, such as a face, has been demonstrated by the inventors by using eye-tracking analysis. Eye-tracking analysis is one of the research tools that enable the study of eye movements and visual attention. It is known that humans set their visual attention to a restricted number of areas in an image, as discussed in (1) A. L. Yarbus. Eye Movements and Vision, Plenum Press, New York N.Y., 1967, (2) M. I. Posner and S. E. Petersen, “The attention system of the human brain (review)”, Annu. Rev. Neurosciences, 1990, 13:25-42 and (3) J. Senders. “Distribution of attention in static and dynamic scenes,” In Proceedings SPIE 3016, pages 186-194, San Jose, February 1997. Even when viewing time is increased, the focus remains on those areas and are most often highly correlated amongst viewers.

Different visual attention strategies are required to capture real-time information through visual content and caption reading. There exists a large body of literature on visual attention for each of these activities (see, for instance, the review of K. Rayner, “Eye movements in reading and information processing: 20 years of research”, Psychological Bulletin, volume 124, pp 372-422, 1998. However, little is known on how caption readers balance viewing and reading.

The work of Jensema described in (1) C. Jensema, “Viewer Reaction to Different Television Captioning Speed”, American Annals of the Deaf, 143 (4), pp. 318-324, 1998 and (2) C. J. Jensema, R. D. Danturthi, R. Burch, “Time spent viewing captions on television programs” American Annals of the Deaf, 145(5), pp 464-468, 2000 covers many aspects of caption reading. Studies span from the reaction to caption speed to the amount of time spent reading caption. The document C. J. Jensema, S. Sharkawy, R. S. Danturthi, “Eye-movement patterns of captioned-television viewers”, American Annals of the Deaf, 145(3), pp. 275-285, 2000 discusses an analysis of visual attention using an eye-tracking device. Jensema found that the coupling of captions to a moving image created significant changes in eye-movement patterns. These changes were not the same for the deaf and hearing impaired compared to a hearing group. Likewise, the document G. D'Ydewalle, I. Gielen, “Attention allocation with overlapping sound, image and text”, In Eyes movements and visual cognition”, Springer-Verlag, pp 415-427, 1992 discusses attention allocation with a wide variety of television viewers (children, deaf, elderly people). The authors concluded that this task requires practice in order to effectively divide attention between reading and viewing and that behaviors varied among the different group of viewers. Those results suggest that even though different viewers may have different ROI, eye-tracking analysis would help identify them.

Furthermore, research on cross-modality plasticity, which analyses the ability of the brain to reorganize itself if one sensory modality is absent, shows that deaf and hearing impaired people have developed more peripheral vision skills than the hearing people, as discussed in R. G. Bosworth, K. R. Dobkins, “The effects of spatial attention on motion processing in deaf signers, hearing signers and hearing non signers”, Brain and Cognition, 49, pp 152-169, 2002. Moreover, as discussed in J. Proksch, D. Bavelier, “Changes in the spatial distribution of visual attention after early deafness”, Journal of Cognitive Neuroscience, 14:5, pp 687-701, 2002, the authors found that this greater resources allocation of the periphery comes at the cost of reducing their central vision. So, understanding how this ability affects visual strategies could provide insights on efficient caption localization and eye-tracking could reveal evidences of those strategies.

Test conducted by the inventors using eye-tracking analysis involving 18 participants (nine hearing and nine hearing-impaired) who viewed a dataset of captioned motion videos representing five types of television content show that it is desirable to create a visual association between the caption and the ROI. The results of the study are shown in Table 1. For each type of motion video, two excerpts were selected from the same video source with equivalent criteria. The selection criteria were based on the motion level they contained (high or low according to human perception) and their moderate to high caption rate (100 to 250 words per minute). For each video, a test was developed to measure the information retention level on the visual content and on the caption.

TABLE 1
Dataset Description

| Video | | Motion | Caption | Total nb. | Length |
|---|---|---|---|---|---|
| id. | Type | Level | rate | Shots | (frame) |
| video 1 | Culture | Low | High | 21 | 4,037 |
| video 2 | Films | High | Moderate | 116 | 12,434 |
| video 3 | News | Low | High | 32 | 4,019 |
| video 4 | Documentary | Low | Moderate | 11 | 4,732 |
| video 5 | Sports | High | High | 10 | 4,950 |
| | | | | 190 | 30,172 |

The experiment was conducted in two parts:
all participants viewed five videos and were questioned about the visual and caption content in order to assess information retention. Questions were designed so that reading the caption could not give the answer to visual content questions and vice versa;
when participants were wearing the eye-tracker device, calibration was done using a 30 points calibration grid. Then, all participants viewed five different videos. In this part, no questions were asked between viewings to avoid disturbing participants and altering calibration.

Eye-tracking was performed using a pupil-center-corneal-reflection system. Gaze points were recorded at a rate of 60 Hz. Data is given in milliseconds and the coordinates are normalized with respect to the size of the stimulus window.

### 1. Analysis of Fixation on ROIs

Eye fixations correspond to gaze points for which the eye remains relatively stationary for a period of time, while saccades are rapid eye movements between fixations. Fixation identification in eye-tracking data can be achieved with different algorithms. An example of such algorithm is described in S. Josephson, “A Summary of Eye-movement Methodologies”, http://www.factone.com/article_{—}2.html, 2004. A dispersion-based approach was used in which fixations correspond to consecutive gaze points that lie in close vicinity over a determined time window. Duration threshold for a fixation was set to 250 milliseconds. Every consecutive point within a window of a given duration are labeled as fixations if their distance, with respect to the centroid, corresponds to a viewing angle inferior or equal to 0.75 degree.
A ground truth (GT) was build for the video in which identified potential regions of interest were identified such as caption (fixed ROIs) as well as face, a moving object and embedded text in the image (dynamic ROIs). The eye-tracking fixations done inside the identified ROI were analyzed. Fixations that could be found outside the ROIs were also analyzed to see if any additional significant regions could also be identified. Fixations done on caption were then compared against fixations inside the ROI.

### 2. Fixations Inside the ROIs

In order to validate fixations inside the ROIs, the number of hits in each of them was computed. A hit is defined as one participant having made at least one fixation in a specified ROI. The dataset used included a total of 297 ROIs identified in the GT. Table 2, shows that a total of 954 actual hits (AH) were done by the participants over a total of 2,342 potential hits (PH). The hearing-impaired (IMP) viewers hit the ROIs 43% of the time compared to 38% for the hearing group (HEA). This result suggests that both groups were attracted almost equally by the ROIs. However, result per video indicated that for some specific video, interest in the ROIs was different.

TABLE 2
Actual and potential hits inside ROI

| | Actual | Potential | |
|---|---|---|---|
| | hits | hits | % |
| Impaired | 561 | 1,305 | 43% |
| (IMP) | | | |
| Hearing | 393 | 1,037 | 38% |
| (HEA) | | | |

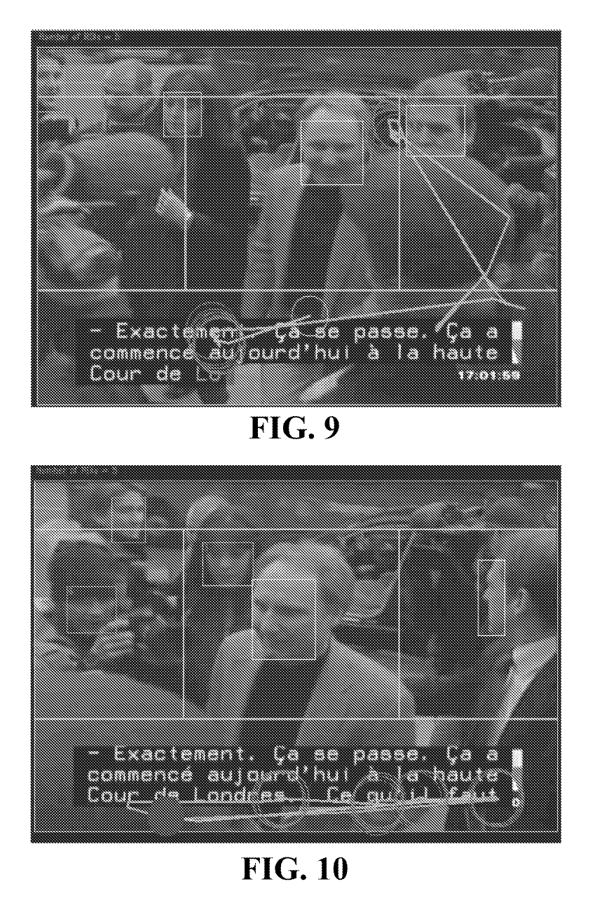

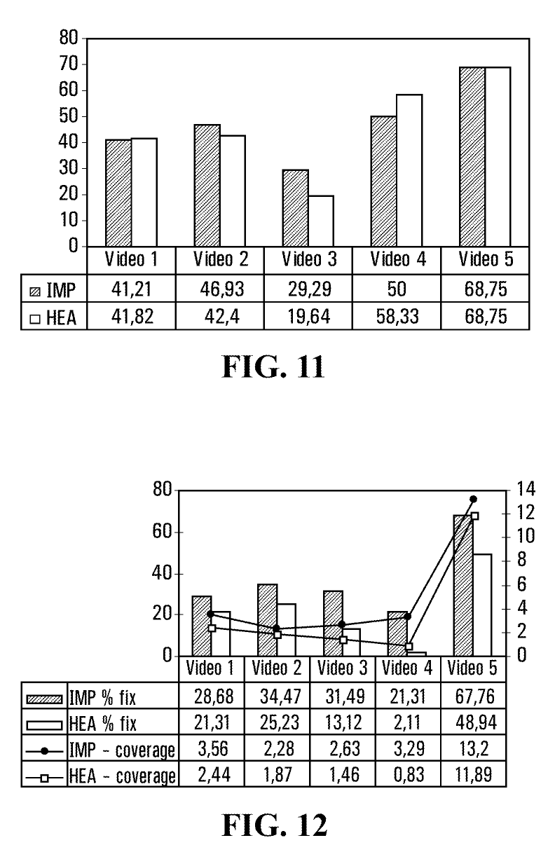

FIG. 11 shows a graph which compares the actual hits per motion picture video. The results show that in most videos, more than 40% of AH (for both groups) was obtained. In these cases, the selected ROIs were good predictors of visual attention. But in the case of motion video 3 (news), the ROI selection was not as good, since only 29.29% of AH is observed for IMP and 19.64% for HEA. A more detailed analysis shows that ROIs involving moving faces or objects blurred by speed tend to be ignored by most participants.
The better performance of IMP was explained by the fact that multiple faces received their attention by IMP, as shown in FIG. 9 but not by HEA, as shown in FIG. 10. The analysis also revealed that the faces of the news anchors, which are seen several times in prior shots, are ignored by IMP in latter shots. A similar behavior was also found on other motion videos where close-up images are more often ignored by IMP. It would seem that IMP rapidly discriminate against repetitive images potentially with their peripheral vision ability. This suggests that placing captions close to human face or close-up images would facilitate viewing.

### 3. Fixations Outside ROIs

To estimate if visual attention was directed outside the anticipated ROIs (faces, moving objects and captions), fixations outside all the areas identified in the GT were computed. One hundred potential regions were defined by dividing the screen in 10×10 rectangular regions. Then two measures were computed: percentage of fixations in outside ROIs and coverage ratio. The percentage indicates the share of visual attention given to non-anticipated regions, while the coverage reveals the spreading of this attention over the screen. High percentage of fixations in those regions could indicate the existence of other potential ROIs. Furthermore, to facilitate identification of potential ROIs, the coverage ratio can be used as an indicator as to whether attention is distributed or concentrated. A distributed coverage would mainly suggest a scanning behavior as opposed to a focus coverage which could imply visual attention given to an object of interest. Comparing fixations outside ROIs, as shown in table 3 reveals that IMP (37.9%) tends to look more outside ROIs than HEA (22.7%).

TABLE 3
Fixations outside ROIs

| | Total | Outside | |
|---|---|---|---|
| | fixations | fixations | % |
| Impaired (IMP) | 60,659 | 22,979 | 37.9% |
| Hearing (HEA) | 59,009 | 13,377 | 22.7% |

When considering the results per type of video, as illustrated by the graph in FIG. 12, most video types had a percentage of fixations outside the ROIs below 35% with low coverage ration (below 4%). This indicates that some ROIs were missed but mostly in specific areas. But the exact opposite is observed for video 5 which has the highest percentage of fixations outside ROIs (67.78 for IMP and 48.94 for HEA) with a high coverage ratio. This indicates that many ROIs were not identified in many area of the visual field.
Video 5 had already the highest percentage of AH of inside ROIs, as shown by the graph of FIG. 12. This indicates that although we had identified a good percentage of ROIs, they were still many others ROIs left out. In the GT, the hockey disk was most often identified as a dynamic ROI but in a IS more detailed analysis revealed that participants mostly look at the players. This suggests that ROIs in sports may not always be the moving object (e.g. disk or ball), but the players (not always moving) can become the center of attention. Also, several other missing ROIs were identified, for instance, the gaze of IMP viewers was attracted to many more moving objects than expected.

These results suggest that captions should be placed in a visual association with the ROI such as to facilitate viewing.

A visual association between an ROI and a caption is established when the caption is at a certain distance of the ROI. The distance can vary depending on the specific application; in some instances the distance to the ROI can be small while in others in can be larger.

Generally, the process of selecting the placement of the caption such that it is in a visual association with the ROI includes first identifying a no-caption area in which the caption should not be placed to avoid masking the ROI. When the ROI is a face, this no-caption area can be of a shape and size sufficient to cover most if not all of the face. In another possibility, the no-caption area can be of a size that is larger than the face. Second, the process includes identifying at least two possible locations for the caption in the frame, where both locations are outside the no-caption area and selecting the one that is closest to the ROI.

Note that in many instances more than two positions will exist in which the caption can be placed. The selection of the actual position for placing the caption does not have to be the one that is closest to the ROI. A visual association can exist even when the caption is placed in a position that is further away from the ROI than the closest position that can potentially be used, provided that a third position exists that is further away from the ROI than the first and the second positions.

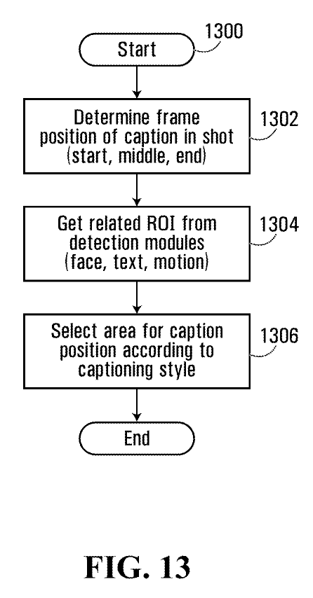

The production rules engine 34 generally operates according to the flowchart illustrated in FIG. 13. The general purpose of the processing is to identify areas in the image that are not suitable to receive a caption, such as ROIs, or high motion areas. The remaining areas in which a caption can be placed are then evaluated and one or more is picked for caption placement.

FIG. 13 is a flowchart illustrating the sequence of events during the processing performed by the production rules engine. This sequence is made for each caption to be placed in a motion video picture frame. When two or more captions need to placed in a frame, the process is run multiple times.

The process starts at 1300. At step 1302 the production rules engine 34 determines the frame position of caption in shot, for instance does the frame occurs at the beginning of the shot, the middle or the end. This determination allows selecting the proper set of rules to use in determining the location of the caption in the frame and its parameters. Different rules may be implemented depending on the frame position in the shot.

At step 1304, the ROI related information generated IS by the face detection module 20, the text detection module 22 and the motion mapping module 30 is processed. More specifically, the production rules engine 34 analyzes motion activity grid built by the motion mapping module 30. The motion activity grid segments the frame in a grid-like structure of slots where each slot can potentially receive a caption. If there are any specific areas in the image where high motion activity takes place, the production rules engine 34 disqualifies the slots in the grid that coincide to those high motion activity areas such as to avoid placing captions where they can mask important action in the image.

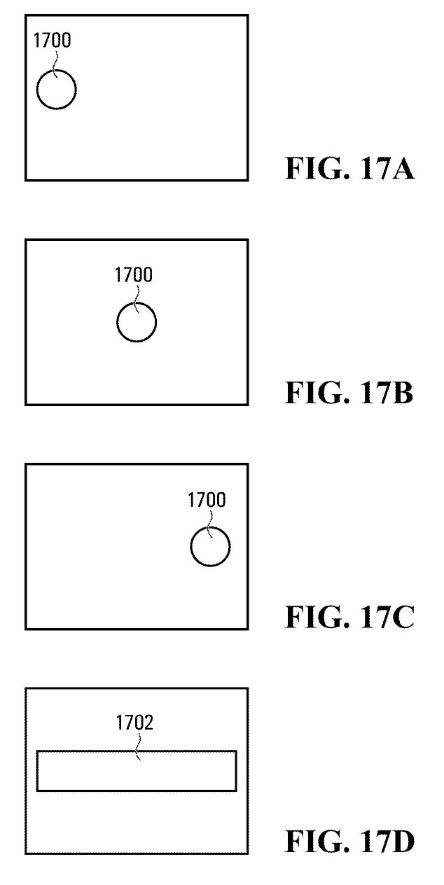

Note that the motion activity grid is processed for a series of frames that would contain the caption. For example, if an object shown in the image is moving across the image and that movement is shown by the set of frames that contain a caption, the high motion area that need to be protected from the caption (to avoid masking the high motion area), in each of the frames, is obtained by aggregating the image of the moving object from all the frames. In other words the entire area swept by the moving object across the image is protected from the caption. This is best shown by the example of FIGS. 17a, 17b, 17c and 17d which shows three successive frames in which action is present, namely the movement of a ball.

FIG. 17a shows the first frame of the sequence. The ball 1700 is located at the left side of the image. FIG. 17b is next frame in the sequence and it shows the ball 1700 in the center position of the image. FIG. 17c is the last frame of the sequence where the ball 1700 is shown at the right side of the image. By successively displaying the frames 17a, 17b and 17c, the viewer will see the ball 17 moving from left to the right.

Assume that a caption is to be placed in the three frames 17a, 17b and 17c. The production rules engine 34 will protect the area 1702 which is the aggregate of the ball image in each frame 17a, 17b and 17c and that defines the area swept by the ball 1700 across the image. The production rules engine, therefore locate the caption in each frame such that it is outside the area 1702. The area 1702 is defined in terms of number and position of slots in the grid. As soon as the ball 1700 occupies any slot in a given frame of the sequence, that slot is disqualified from every other frame in the sequence.

The production rules engine 34 will also disqualify slots in the grid that coincide with the position of other ROIs, such as those identified by the face detection module 20 and by the text detection module 22. This process would then leave only the slots in which a caption can be placed and that would not mask, ROIs and important action on the screen.

Step 1306 then selects a slot for placing the caption, among the slots that have not been disqualified. The production rules engine 34 selects the slot that is closest to the ROI associated with the caption among other possible slots such as to create the visual association with the ROI. Note that in instances where different ROIs exist and the caption is associated with only one of them, for instance several human faces and the caption represents dialogue associated with a particular one of the faces, further processing will be required such as to locate the caption close to the corresponding ROI. This may necessitate synchronization between the caption, the associated ROI and the associated frames related to the duration for which the caption line is to stay visible. For example, the placements of an identifier in the caption and a corresponding matching identifier in the ROI to allow properly matching the caption to the ROI.

Referring back to FIG. 3, the output 35 of the production rules engine 34 is information specifying the location of a given caption in the image. This information can then be used by post processing devices to actually integrate the caption in the image and thus output a motion video signal including captions. Optionally, the post processing can use a human intervention validation or optimization step where a human operator validates the selection of the caption position or optimizes the position based on professional experience. For example, visible time of caption can be shortened depending on human judgment since some words combination are easier to read or predictable; this may shorten the display of caption to leave more attention to the visual content.

A specific example of implementation will now be described which will further assist in the understanding of the invention. The example illustrates of the different decisions made by the production rules engine 34 when applied to a particular shot of a French movie where motion, two faces and no text have been detected. The caption is displayed in pop-up style on one or two lines of 16 characters maximum.

Since the film as a rate of 25 fps, single line captions are visible for 25 frames, while captions made of two lines are displayed for 37 frames, as shown in table 4. The first speech is said at time code 6:43.44 (frame 10086) but caption is put on the first frame at the start of the shot (frame 10080). The last caption of the shot is started at frame 10421 so that it lasts 25 frames till the first frame of the next shot (frame 10446).

TABLE 4

| Start | End | | | | |
|---|---|---|---|---|---|
| (frame | (frame | | Number of | | Frame |
| number) | number) | Caption | characters | Lines | number |
| 10080 | 10117 | Amélie | 29 | 2 | 10086 |
| | | Poulin, | | | |
| | | serveuse au . . . | | | |
| 10135 | 10154 | Deux | 13 | 1 | 10135 |
| | | Moulins. | | | |
| 10165 | 10190 | Je sais. | 8 | 1 | 10165 |
| 10205 | 10242 | Vous | 24 | 2 | 10205 |
| | | rentrez | | | |
| | | bredouille, | | | |
| 10312 | 10275 | de la | 28 | 2 | 10275 |
| | | chasse aux | | | |
| | | Bretodeau. | | | |
| 10407 | 10370 | Parce que | 26 | 2 | 10370 |
| | | ça n'est | | | |
| | | pas Do. | | | |
| 10421 | 10446 | C'est To. | 9 | 1 | 10422 |

Other captions are synchronized with speech since none are overlapping. If overlapping between two captions occurs, the production rules engine 34 tries to show the previous captions earlier.

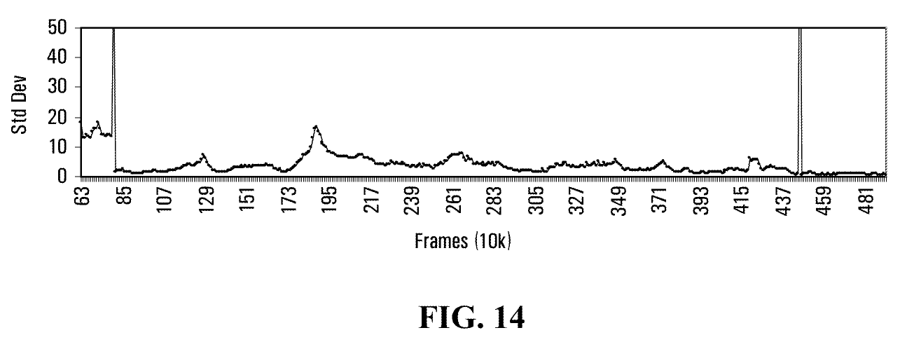

Then, the actual placement is done based on the Motion Activity Grid (MAG). The velocity magnitude of the visual frame sequence indicates that the maximum motion for the shot is between frame 10185 and 10193 with the highest at frame 10188. This is shown by the graph at FIG. 14.

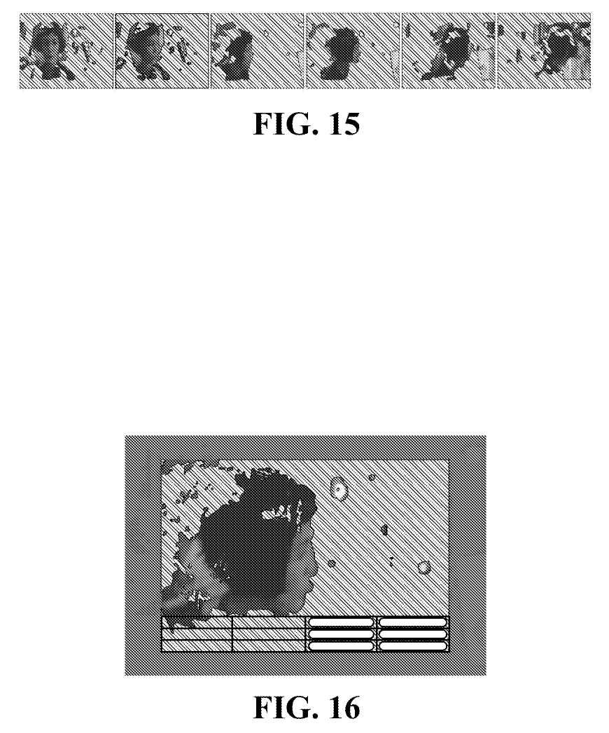

During this time, the third caption “Je sais” must be displayed from frame 10165 to 10190 and is said by a person not yet visible in the scene. In the high motion set of frames, the first speaker is moving from the left to the right side of the image, as shown by the series of thumbnails in FIG. 15.

After establishing the MAG at the highest motion point, the caption region is reduced to six potential slots, i.e. three last lines of column three and four, as shown in FIG. 16. By frame 10190, only the three slots of column four will be left since the MAG of successive frames will have disqualified column three.

Since caption requires only one line, it will be placed in the first slot of column four, which is closest to the ROI, namely the face of the person shown in the image in order to create a visual association with the ROI.

In another possibility the system 10 can be used for the placement of captions that are of the roll-up or the scroll mode style. In those applications, the areas where a caption appears are pre-defined. In other words, there are at least two positions in the image, that are pre-determined and in which a caption can be placed. Typically, there would be a position at the top of the image or at the bottom of the image. In this fashion, a roll-up caption or a scroll mode caption can be placed either at the top of the image or at the bottom of it. The operation of the production rules engine 34 is to select, among the predetermined possible positions, the one in which the caption is to be placed. The selection is made on the basis of the position of the ROIs. For instance, the caption will be switched from one of the positions to the other such as to avoid masking an ROI. In this fashion, a caption that is at the bottom of the image will be switched to the top when an ROI is found to exist in the lower portion of image where it would be obscured by the caption.

Although various embodiments have been illustrated, this was for the purpose of describing, but not limiting, the invention. Various modifications will become apparent to those skilled in the art and are within the scope of this invention, which is defined more particularly by the attached claims. For instance, the examples of implementation of the invention described earlier were all done in connection with captions that are subtitles. A caption, in the context of this specification is not intended to be limited to subtitles and can be used to contain other types of information. For instance, a caption can contain text, not derived or representing a spoken utterance, which provides a title short explanation or a description associated with the ROI. The caption can also be a visual annotation that describes a property of the ROI. For example, the ROI can be an image of a sound producing device and the caption can be the level of the audio volume the sound producing device makes. Furthermore, the caption can include a control that responds human input, such as a link to a website that the user “clicks” to load the corresponding page on the display. Other examples of caption include symbols, graphical elements such as icons or thumbnails.

1) A method for determining a location of a caption in a video signal associated with a ROI, wherein the video signal includes a sequence of video frames, the method comprising:
a) processing the video signal with a computing device to generate ROI location information, the ROI location information conveying the position of the ROI in at least one video frame of the sequence;
b) determining with the computing device a position of a caption within one or more frames of the video signal on the basis of the ROI location information, the determining, including:
i) identifying at least two possible positions for the caption in the frame such that the placement of the caption in either one of the two positions will not mask fully or partially the ROI;
ii) selecting among the at least two possible positions an actual position in which to place the caption, at least one of the possible positions other than the actual position being located at a longer distance from the ROI than the actual position;
c) outputting at an output data conveying the actual position of the caption.

2) A method as defined in claim 1, wherein the ROI includes a human face.

3) A method as defined in claim 1, wherein the ROI includes an area containing text.

4) A method as defined in claim 1, wherein the ROI includes a high motion area.

5) A method as defined in claim 2, wherein the caption includes subtitle text.

6) A method as defined in claim 2, wherein the caption is selected in the group consisting of subtitle text, a graphical element and a hyperlink.

7) A method as defined in claim 1, including distinguishing between first and second areas in the sequence of video frames, wherein the first area includes a higher degree of image motion than the second area, the identifying including disqualifying the second area as a possible position for receiving the caption.

8) A method as defined in claim 1, including processing the video signal to partition the video signal in a series of shots, wherein each shot includes a sequence of video frames.

9) A method as defined in claim 1, including selecting among the at least two possible positions an actual position in which to place the caption, the actual position being located at a shortest distance from the ROI than any one of the other possible positions.

10) A system for determining a location of a caption in a video signal associated with a ROI, wherein the video signal includes a sequence of video frames, the system comprising:
a) an input for receiving the video signal;
b) an ROI detection module to generate ROI location information, the ROI location information conveying the position of the ROI in at least one video frame of the sequence;
c) a caption positioning engine for determining a position of a caption within one or more frames of the video signal on the basis of the ROI location information, the caption positioning engine:
i) identifying at least two possible positions for the caption in the frame such that the placement of the caption in either one of the two positions will not mask fully or partially the ROI;
ii) selecting among the at least two possible positions an actual position in which to place the caption, at least one of the possible positions other than the actual position being located at a longer distance from the ROI than the actual position;
d) an output for releasing data conveying the actual position of the caption.

11) A system as defined in claim 10, wherein the ROI includes a human face.

12) A system as defined in claim 10, wherein the ROI includes an area containing text.

13) A system as defined in claim 10, wherein the ROI includes a high motion area.

14) A system as defined in claim 11, wherein the caption includes subtitle text.

15) A system as defined in claim 11, wherein the caption is selected in the group consisting of subtitle text, a graphical element and a hyperlink.

16) A system as defined in claim 10, wherein the ROI detection module distinguishes between first and second areas in the sequence of video frames, wherein the first area includes a higher degree of image motion than the second area, the caption positioning engine disqualifying the second area as a possible position for receiving the caption.

17) A system as defined in claim 10, including a shot detection module for processing the video signal to partition the video signal in a series of shots, wherein each shot includes a sequence of video frames.

18) A system as defined in claim 10, the caption positioning engine selecting among the at least two possible positions an actual position in which to place the caption, the actual position being located at a shortest distance from the ROI than any one of the other possible positions.

19) A method for determining a location of a caption in a video signal associated with a ROI, wherein the video signal includes a sequence of video frames, the method comprising:
a) processing the video signal with a computing device to generate ROI location information, the ROI location information conveying the position of the ROI in at least one video frame of the sequence;
b) determining with the computing device a position of a caption within one or more frames of the video signal on the basis of the ROI location information, the determining, including:
i) selecting a position in which to place the caption among at least two possible positions, each possible position having a predetermined location in a video frame, such that the caption will not mask fully or partially the ROI;
c) outputting at an output data conveying the selected position of the caption.

20) A method as defined in claim 19, wherein the ROI includes a human face.

21) A method as defined in claim 19, wherein the ROI includes an area containing text.

22) A method as defined in claim 19, wherein the ROI includes a high motion area.

23) A method as defined in claim 20, wherein the caption includes subtitle text.

24) A method as defined in claim 23, wherein the caption is selected in the group consisting of subtitle text, a graphical element and a hyperlink.
